(19) United States
(12) Patent Application Publication
(10) Pub. No.: US 2025/0131556 A1
(43) Pub. Date: Apr. 24, 2025

(54) AUTOFOCUS

(71) Applicant: Brainlab AG, Munich (DE)

(72) Inventors: Manfred WEISER, Munich (DE); Jörg UHDE, Munich (DE)

(21) Appl. No.: 18/682,215

(22) PCT Filed: Sep. 29, 2021
(86) PCT No.: PCT/EP2021/076851

§ 371 Date: Feb. 8, 2024

(51) Int. Cl. G06T 7/00; G06T 7/136; G06T 7/73

(52) U.S. Cl. CPC G06T 7/0012; G06T 7/136; G06T 7/73; G06T 7/97; G06T 2207/10116; G06T 2207/30008; G06T 2207/30052

(57) ABSTRACT

Provided is a computer-implemented method for assessing a medical image of an object imaged with an X-ray system. The method proposes to generate one or more positioning data sets, which differ in at least one positioning parameter. The X-ray system images medical images of the object with the one or more positioning data sets. The obtained medical images were assessed by measuring a quality measure in the medical images and comparing the measured quality measures with an evaluation criterion. A positive assessed medical image with the corresponding positioning data is then provided for further processing.

### FIELD OF THE INVENTION

The present disclosure relates to a medical computer-implemented method of assessing an imaging quality measure of medical images, to a device for assessing a quality measure of medical images, to a system for obtaining a medical image of an object and to a computer program element.

### TECHNICAL BACKGROUND

Medical imaging has an important impact on diagnostics. Radiation based medical imaging such as X-ray imaging or CT-imaging are known in the state of art and widely used. Medical imaging is therefore an important issue in medical treatment of patients. Assessment whether a medical image has an adequate quality is a difficult task for technicians and crucial for diagnostics and subsequent treatments of a patient. It has been found that a further need exists to assist a technician for assessing an image quality of medical images.

### EXEMPLARY SHORT DESCRIPTION OF THE INVENTION

The invention proposes a computer implemented method for assessing a medical image of an object imaged with an X-ray system. The method proposes to generate one or more positioning data sets, which differ in at least one positioning parameter. The X-ray system images medical images of the object with the one or more positioning data sets. The obtained medical images are assessed by measuring a quality measure in the medical images and comparing the measured quality measures with a predefined threshold. A positive assessed medical image with the corresponding positioning data is then provided for further processing.

### GENERAL DESCRIPTION OF THE INVENTION

It is an object of the present invention to provide a possibility to assess an image quality of medical images. This and other objects, which become apparent upon reading the following description, are solved by the subject matter of the independent claims. The dependent claims refer to preferred embodiments of the invention.

According to a first aspect of the present disclosure a medical computer-implemented method of assessing an imaging quality measure of medical images is provided, comprising the steps of: receiving a first positioning data set configured to position an imaging source and an imaging detector of a medical imaging X-ray system in relation to an object to be imaged into a first imaging position; obtaining a first medical image of the object from the first imaging position; generating at least a second positioning data set configured to position the imaging source and the imaging detector of the medical imaging X-ray system in relation to the object to be imaged into a second imaging position, wherein the second positioning data set differs from the first positioning data set in at least one positioning parameter; obtaining at least a second medical image of the object from the second imaging position; determining at least one imaging quality measure in the first medical image and the at least second medical image and comparing the determined at least one imaging quality measure with a predefined threshold of the at least one imaging quality measure and deriving an assessment result; A) in case of a positive assessment result of the first medical image or the at least second medical image selecting of the respective medical image with the positive assessment result and providing the selected medical image and the corresponding positioning data set for further processing, and B) in case of a negative assessment result of the first medical image or the at least second medical image generating at least one further positioning data set configured to position the imaging source and the imaging detector of the medical imaging X-ray system in relation to the object to be imaged into a further imaging position, and obtaining at least one further medical image from the further imaging positioning, wherein the at least one further positioning data set differs from the first positioning data set and the second positioning data set in at least one positioning parameter, and deriving an assessment result of the at least one further medical image.

The imaging quality measure, as used herein, is to be understood broadly and relates to any measure configured to assess a quality of a medical image. The imaging quality measure may comprise a geometrical characteristic (e.g. ration of side-lengths of an implant, a specific outline shape that matches after a scaling process etc.) in a medical image, a color, or intensity value or value distribution in a medical image (e.g. lightness of one or more areas in a medical image or a color or intensity gradient), simulated image data (e.g. digital reconstructed radiograph). The term medical image, as used herein, is to be understood broadly and relates to any image data derived from a medical imaging from an X-ray system. The term positioning data, as used herein, is to be understood broadly and relates to any data configured to position an X-ray source and/or an X-ray detector. The positioning data set may comprise one or more translatory values, one or more rotatory values. The positioning data may be described in relative values (e.g. X-ray source+10 mm in×direction) and/or in absolute values (e.g. in values of an X-ray coordinate system). The term object, as used herein, is to be understood broadly and relates to a medical equipment (e.g. a screw) arranged in an anatomical part (e.g. a leg or a spinal bone) of a human or an animal (e.g. shepherd dog) or to an anatomical part (e.g. a bone). The term positioning parameter, as used herein, is to be understood broadly and relates to any parameter configured to position an X-ray source and/or an X-ray detector. The positioning parameter may be a parameter of the positioning data set. The positioning parameter may be a translatory value (e.g. x-position of an X-ray source or an X-ray detector) or a rotatory value (e.g. alpha angle of an X-ray source or an X-ray detector) or a combination of both. The term evaluation criterion, as used herein, is to be understood broadly and relates in particular to a criterion configured to evaluate a medical image. The evaluation criterion may be absolute or relative, as will be explained hereinafter in the context of particular embodiments. The evaluation criterion may be a predefined threshold. The predefined threshold may comprise, in one non-limiting example, one or more lengths of the depiction of the object (e.g. length of the screw, e.g. 100 pixel on the detector and an upper threshold 100.1 pixel and a lower threshold 99.9 pixel). The assessment result may be positive (e.g., measured length of the screw is between the upper threshold and the lower threshold, e.g. 100.05 pixel). The quality criterion may be derived from the determined at least one imaging quality measure in the first medical image and in the at least second medical image. E.g., in case the quality measure is a length or diameter of the depiction of the object, the evaluation criterion may be a maximum or minimum of the measured diameters or lengths (in case of at least three medical images). In case, only two medical images are present, the evaluation criterion may be calculated by a comparison (e.g., the larger length is desired or the smaller length is desired).

Thus, as is understood by the skilled reader from the present disclosure, the evaluation criterion disclosed herein can be embodied as an evaluation criterion that has to be defined in advance (i.e. evaluation criterion corresponds to a predefined threshold) or as an evaluation criterion that is or has to be defined during the method (i.e. evaluation criterion is derived from at least the first medical and second medical image and optionally from further medical images). An example for a predefined threshold is that the object in the medical image should be circular and not oval. Such a threshold can be defined in advance and the predefined threshold is independent from a number of taken medical images. The evaluation criterion that is or has to be defined during the method fits especially to quality measures, which are subject to scaling due to imaging (e.g. length, diameter etc.). Due to the cone projection of X-rays, the depicted length of an object is not invariant under the projection. Such quality measures require for assessing an evaluation criterion, which is derived from the medical images itself. The evaluation criterion may be derived by calculating a minimum or a maximum of the quality measure of the plurality of medical images. The evaluation criterion may comprise a size comparison (e.g. in case the length of the object in the second image is bigger than in the first medical image a termination criterion is achieved). The evaluation criterion that is to be defined during the method may also be used with other quality measures that are not affected by scaling. E.g., the evaluation criterion may be derived from one of the following a shape, a color, a grayscale, a gradient, a distribution of the latter.

In other words, the invention is based on the knowledge that the quality of medical images obtained with X-ray imaging depends on an adequate positioning of an X-ray source and/or an X-ray detector of an X-ray system in relation to an object to be imaged. For example in case a screw is inserted in a broken leg of a patient, first positioning data may be received from guidelines for anatomical imaging for this case. The guidelines for anatomical imaging in this case may comprise positioning data that lead to a certain side view of the screw in the leg. However, the first positioning data only serve as an initial positioning data set that may not lead to an adequate quality of the medical image (e.g. due to a rotation of the leg with the screw during imaging process). An operator operating the X-ray system may not realize that the quality of the medical image is not sufficient and/or how to solve this problem in a systematic manner. In general, the operator carries out a trial and error approach that may not be efficient and/or successful. The invention proposes to solve such a problem by generating at least a second positioning data set and obtaining a second medical image. The invention further proposes to solve the problem by determining and assessing an imaging quality measure of the first medical image and the second medical image. In case of an adequate imaging quality measure of the first medical image or the second medical image the invention stops the imaging process and provides the positive assessed medical image for further processing. In case of an inadequate imaging quality measure of the first medical image or the second medical image the invention repeats the steps of generating a further positioning data set, obtaining a further medical image, determining an image quality measure of the further medical image and deriving an assessment result. In sum, this may advantageously lead to an increased quality of the medical image, to a reduction of a radiation exposure, as fewer trials for imaging of the object are necessary, to an increase of an efficiency and to a reduction of complexity.

In an embodiment, the at least one imaging quality measure is a maximum depicted length of the object. E.g., the object is a pin inserted in a leg and a desired medical image shall comprise a side view of the pin in the leg. An X-ray detector and an X-ray source have to be positioned accordingly in front and behind the leg comprising the pin in order to obtain the desired side view. The imaging quality measure may then be determined by measuring (e.g. with an image processing algorithm such as image segmentation) the length of the screw. This may advantageously increase the efficiency of the imaging process and the quality of the medical image.

In an embodiment, the at least one imaging quality measure may be a minimum area of the object. E.g., the object is a screw inserted in an arm of a human and a desired medical image shall comprise a top view of the screw in the arm. An X-ray detector and an X-ray source have to be positioned accordingly above and below the arm comprising the screw in order to obtain the desired side view. The imaging quality measure may then be determined by measuring the surface of the screw head. This may advantageously increase the efficiency of the imaging process and the quality of the medical image.

In an embodiment, the at least one imaging quality measure may be an aspect ratio of the object. The aspect ratio, as used herein, is defined by a ratio of a length of an object to a width of the object. By means of an image processing algorithm the aspect ratio may be determined. E.g., the object is a screw inserted in an arm of a human and a desired medical image shall comprise a view in a certain angle to the screw in the arm. The view in a certain angle may be described by a certain aspect ratio of the screw. The aspect ratio may then be determined by measuring a length and width of the screw by means of an image processing algorithm. This may advantageously increase the efficiency of the imaging process and the quality of the medical image.

In an embodiment, the at least one imaging quality measure may be a contour of the object. The term contour, as used herein, means a shape or outline of an object in a medical image. The contour may be measured with an image processing algorithm. E.g., the object is a plate with a width of 5 mm and a length of 20 mm, wherein the plate may be arranged on the arm of a patient. The contour may then be measured by measuring the ratio of the length and the width. This may advantageously increase the efficiency of the imaging process and the quality of the medical image.

In an embodiment, the at least one imaging quality measure may be a digital reconstructed radiograph of the object. The digital reconstructed radiograph of the object may be derived from a simulation through a perspective projection of a 3D model comprising the object (e.g. screw in an arm of patient) onto a two-dimensional image plane. By means of a comparison (e.g. with an image processing algorithm) of the obtained medical image with the digital reconstructed radiograph differences may be determined. The comparison may be based on a similarity measure like mutual information or a gradient based algorithm. The maximum of the similarity measure may indicate an optimum position and/or image. This may advantageously increase the efficiency of the imaging process and the quality of the medical image.

In an embodiment, the at least one imaging quality measure may be an inner contour of the object. The inner contour (e.g. a shape of a hole) may be measured by determining a similarity of a shape of the imaged hole with an ideal circle. Under non-optimum projections, the inner contour is more like an ellipse or invisible at all. The inner contour may be an inner contour of a hole in a bone of the patient. The inner contour may be an inner contour of a locking hole of a medullary nail arranged in the patient. The inner contour may be an inner contour of an implant arranged in the patient. This may advantageously increase the efficiency of the imaging process and the quality of the medical image.

In an embodiment, the at least one imaging quality measure may be a parameter of a directional change of an intensity or a color. Bones, tissue, implants or the like lead to different colors or intensities in an X-ray image (i.e. radiograph and here medical image). In dependency of a perspective (i.e. view direction) bones, tissue, implant or the like may be arranged differently between an X-ray source and an X-ray detector. In dependency of the perspective, different colors or intensities may be presented in an X-ray image. Hence, there is also a directional change of an intensity or a color measurable by an image processing algorithm. The directional change of an intensity or a color may then be compared with reference values for a specific case (e.g. screw in a hand wrist). E.g., implants may be different in broadness and/or thickness, i.e. depending on a perspective of imaging, different opaque layers are traversed by the radiation.

In an embodiment, the first, the second and the further positioning data set each comprise a first angle (i.e. orbital) and/or a second angle of the imaging source and/or imaging detector in relation to the object. The X-ray system may comprise a C arm X-ray system with at least two degrees of freedom, first angle (i.e. orbital angle) and a second angle. The object may be placed on a support structure (e.g. a table) and the C arm X-ray system may be arranged around the support structure. The first angle may describe the position of the X-ray source and the X-ray detector within the C arm X-ray system in relation to the object and the second angle may describe the position of the C arm in relation to the X-ray system and to the object. Alternatively, the positioning data set may also comprise one or more positions of the object in relation to the X-ray system.

In an embodiment, the first angle of the imaging source and the first angle of the imaging detector may be positioned independently from each other. In other words, the X-ray source and the X-ray detector may not be arranged in a line. This may advantageous when an anatomical part of the human (e.g. a bone) hides the object (e.g. screw in another bone). This may be advantageous in case the object (e.g. an implant, in particular an orientation of the implant) cannot be arranged centrally in a line between the X-ray source and the X-ray detector. This may improve the quality of a medical image.

In an embodiment, the generation of the at least second positioning data set may comprise adding an incremental change to the at least one positioning parameter of the first positioning data set. The incremental change may be for example a constant value of 1° for the at least one positioning parameter (e.g. orbital angle of C arm X-ray system). In case of two or more positioning parameters to be changed, e.g. firstly a first positioning parameter is changed by adding incremental changes and the best assessed medical image with corresponding positioning data set is used as initial positioning set for the incremental change of second positioning parameter. In other words, in case two or more positioning parameters are considered, a sequential examination of the two or more positioning parameters may be carried out. As an alternative, a combined examination of the two or more positioning parameters may be carried out. The combined examination may be based on a design of experiments in order to reduce the necessary imaging trials. In sum, this may be advantageous in terms of efficiency, quality and reliability of the imaging process.

In an embodiment, the incremental change may be constant or variable in dependency of the assessment result, wherein the assessment result may comprise a range with a plurality of entries, preferably more than 5 entries, most preferably 10 entries. In case, the incremental change is constant (e.g. adding 1° to orbital angle) the generation of the at least second parameter data set is independent from the assessment result, an open control is present. This may be a very simple way to be implemented and therefor a very efficient approach. In case, the incremental change is variable in dependency of the assessment result, a feedback control is present (e.g. proportional feedback control). In case the assessment result deviates far from the evaluation criterion (e.g. predefined threshold, e.g. entry 1 (too little angle) or entry 5 (to high angle) instead of entry 3 (correct angle)) the incremental change may be accordingly high. This may result in a dose reduction, as fewer medical images may be necessary. This may increase the quality of the medical images, as incremental change is variable.

In an embodiment, the object may be a medical element arranged in a human body, in particular wherein the object is one of the following: a screw, a screw head, an intramedullary nail, an implant, a medical instrument, a medical instrument holder, a robotic medical instrument holder.

In an embodiment, the object may be an area of an anatomy of a human body. The area may be an end plate from a bone, an end plate of a vertebra, a rib, a spline, a wrist. The object may be any part of an anatomy of a human body or an animal body.

In an embodiment, obtaining at least a second medical image comprises obtaining a plurality of medical images, in particular 5 to 10 medical images and corresponding positioning data. In other words, not only a second medical image is obtained; instead a row of medical images is obtained and the best assessed is provided for further processing. E.g., the plurality of images may firstly be obtained and afterwards assessed. This may increase the efficiency in terms of machine occupation time.

In an embodiment, the determination of the at least one imaging quality measure in the at least second medical image may be performed directly after the at least second medical image is obtained and before a third or the further medical image is obtained. This may be advantageous as a total number of necessary medical images may decrease in case a second or third medical image already lead to a positive assessment result as no further images may have to be obtained then.

In an embodiment, the determination of the at least one imaging quality measure in the respective first medical image and second medical image may comprise using an image processing algorithm. The image processing algorithm may be a canny edge algorithm or a segmentation algorithm.

A further aspect of the present disclosure relates to a device for assessing a quality measure of medical images, comprising: a receiving unit configured to receive a first positioning data set configured to position an imaging source and an imaging detector of the medical imaging X-ray system in relation to an object to be imaged into a first imaging position; a first obtaining unit configured to obtain a first medical image of the object from the first imaging position; a generating unit configured to generate at least a second positioning data set configured to position the imaging source and the imaging detector of the medical imaging X-ray system in relation to the object to be imaged into a second imaging position, wherein the second positioning data set differs from the first positioning data set in at least one positioning parameter; a second obtaining unit configured to obtain at least a second medical image of the object from the second imaging position; a determining unit configured to determine at least one imaging quality measure in the first medical image and the at least second medical image and comparing the determined at least one imaging quality measure with a predefined threshold of the at least one imaging quality measure and deriving an assessment result, in case of a positive assessment result of the first medical image or the at least second medical image to select of the respective medical image with the positive assessment result and to provide the selected medical image and corresponding positioning data set for further processing, and in case of a negative assessment result of the first medical image or the at least second medical image to generate at least one further positioning data set and to obtain at least one further medical image, wherein the at least one further positioning data set differs from the first positioning data set and the second positioning data set in at least one positioning parameter, and to derive an assessment result of the at least one further medical image. The receiving unit, the first obtaining unit, the generating unit, the second obtaining unit and the determining unit are described as functional units. The functional units may be implemented in using hardware, software, and/or a combination thereof. Hardware may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip, a programmable logic unit, a microprocessor, or any other device capable of responding to and executing instructions in a defined manner. The functional units may include one or more interface circuits. In some examples, the interface circuits may include wired or wireless interfaces that are connected to a local area network (LAN), the Internet, a wide area network (WAN), or combinations thereof. The functionality of any given functional unit may be distributed among multiple hardware and/or software that are connected via interface circuits. The functional units may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof.

A further aspect relates to a system for obtaining a medical image of an object, comprising: a device described above; a medical X-Ray imaging system comprising the imaging source and the imaging detector.

In an embodiment, the imaging source and imaging detector of the medical X-Ray imaging system may be configured to be positioned independently from each other.

A last aspect of the present disclosure relates to a computer program element, which, when being executed by a processor, is adapted to carry out the steps of the method described above.

### BRIEF DESCRIPTION OF THE DRAWINGS

In the following, the present disclosure is described exemplarily with reference to the enclosed figures, in which

FIG. 1 is an illustration of different images qualities;

FIG. 2 is a schematic view of a method according to the preferred embodiment of the present disclosure;

FIG. 3 is a device according to an embodiment of the present disclosure; and

FIG. 4 is a system according to an embodiment of the present disclosure.

### DESCRIPTION OF EMBODIMENT

FIG. 1 is an illustration of different image qualities. FIG. 1 comprises three different schematic alignments 10, 11 and 12 of an X-ray imaging system in relation to an object to be imaged and corresponding resulting images. The object to be imaged is in the present example a screw 15, 19 and 19. The X-ray system comprises an imaging source 14, 18 and 22 and an imaging detector 14, 18 and 22. The screw 14, 18 and 22 is arranged between the imaging source 14, 18 and 22 and the imaging detector 13, 17 and 21. The desired image should be in the present example a top of the screw head. The first schematic alignment 10 leads to a distortion of screw head in the corresponding resulting image 16. The second alignment 11 differs from the first alignment 10 by an angle shift of the imaging source 18 and imaging detector 17 in a first direction 24. The resulting corresponding image 20 shows a larger distortion. The third alignment 12 differs from the first alignment 10 by an angle shift of the imaging source 22 and the imaging detector 21 in a second direction 25 opposite the first direction 24. The resulting corresponding image 26 shows then no distortion.

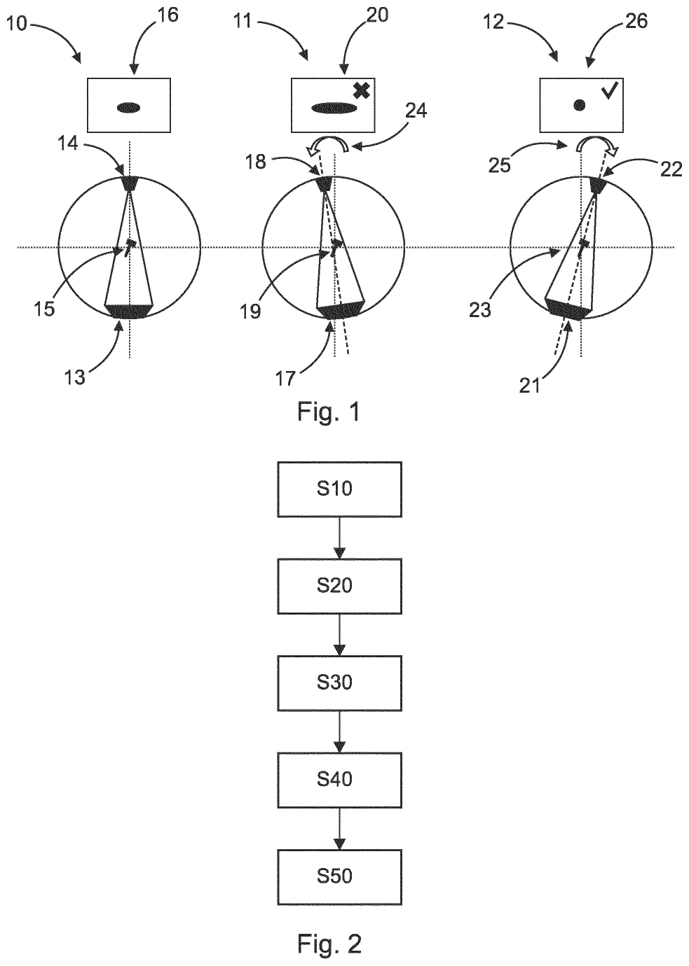

FIG. 2 is a schematic view of a method according to the preferred embodiment of the present disclosure. The computer-implemented method is used for assessing an imaging quality measure of medical images. The method comprises five steps.

Step S10 comprises receiving a first positioning data set configured to position an imaging source and an imaging detector of a medical imaging X-ray system in relation to an object to be imaged into a first imaging position. The object is in the present example implant, e.g. a screw arranged in arm of a patient. Alternatively, the object may be a screw head, an intramedullary nail, an implant, a medical instrument, a medical instrument holder, a robotic medical instrument holder. Alternatively, the object may be an area of an anatomy of a human body. The area may be an end plate from a bone, a rib, a spline, a wrist. The object may be any part of an anatomy of a human body or an animal body. The first positioning data may be received from guidelines for anatomical imaging of a screw in an arm. Alternatively, the first positioning data may be inputted by human interface (e.g. by technician). The first positioning data may comprise one or more translatory values, and/or one or more rotatory values. In the present example, the first positioning data comprise a first angle (i.e.) of the imaging source and the imaging detector. Alternatively, the first positioning data may comprise further a second angle of the imaging source and/or imaging detector. The medical imaging X-ray system is in the present example a C-arm X-ray system, comprising an imaging detector and an imaging source. The imaging detector and the imaging may be positioned independently from each other. Step S20 comprises obtaining a first medical image of the object from the first imaging position. The first medical image is in the present example transmitted from an interface of the medical imaging X-ray system to an obtaining unit carrying out the step S20. Alternatively, the medical imaging X-ray system may obtain the first medical image.

Step S30 comprises generating at least a second positioning data set configured to position the imaging source and the imaging detector of the medical imaging X-ray system in relation to the object to be imaged into a second imaging position, wherein the second positioning data set differs from the first positioning data set in at least one positioning parameter. The at least one positioning parameter is in the present example a first angle (i.e. orbital angle) of the imaging source and the imaging detector. Step S30 is carried out by a generating unit, e.g. a CPU with an interface. Generating of the at least second positioning data comprises in the present example adding an incremental change to the at least one positioning parameter of the first positioning data set. The incremental change may be constant or variable of an assessment result, wherein the assessment result may comprise a range with a plurality of entries, preferably more than 5 entries, most preferably 10 entries. In the present example, the incremental change is constant and comprises 1° for the first angle of the imaging source and imaging detector of medical imaging X-ray system. The generating unit may transmit the at least second positioning data to a control of the medical imaging X-ray system.

Step S40 comprises obtaining at least a second medical image of the object from the second imaging position. Step S40 is carried out in the present example by means of a second obtaining unit. The second obtaining unit may be the same as the first obtaining unit. The medical imaging X-ray system may position the imaging source and the imaging detector according to the at least second positioning data and may image the second image with the second positioning. The medical imaging X-ray system may transmit the at least second image to the second obtaining unit by means of an interface. Alternatively, a plurality of images may be obtained, wherein also in step S20 a plurality of further positioning data may be generated.

Step S50 comprises determining at least one imaging quality measure (e.g. roundness of a hole) in the first medical image and the at least second medical image and comparing the determined at least one imaging quality measure with an evaluation criterion, in the present example a predefined threshold (e.g. roundness of hole=98%) of the at least one imaging quality measure and deriving an assessment result; A) in case of a positive assessment result of the first medical image or the at least second medical image selecting of the respective medical image with the positive assessment result and providing the selected medical image and the corresponding positioning data set for further processing, and B) in case of a negative assessment result of the first medical image or the at least second medical image generating at least one further positioning data set configured to position the imaging source and the imaging detector of the medical imaging X-ray system in relation to the object to be imaged into a further imaging position, and obtaining at least one further medical image from the further imaging positioning, wherein the at least one further positioning data set differs from the first positioning data set and the second positioning data set in at least one positioning parameter, and deriving an assessment result of the at least one further medical image. Alternatively, the determining of the at least one quality measure in the at least second image may be performed directly after the at least second medical image is obtained and before a further medical image is obtained. The determination of the at least one image quality measure in respective first medical image and the second medical image may comprise a using an image processing algorithm, e.g. canny edge algorithm. The at least one imaging quality measure is in the present example the minimum area of the screw head. Alternatively, the imaging quality measure may be one or more of the following maximum length of the object, aspect ratio of the object, contour of the object, digital reconstructed radiograph of the object, inner contour of the object, directional change of an intensity or a color.

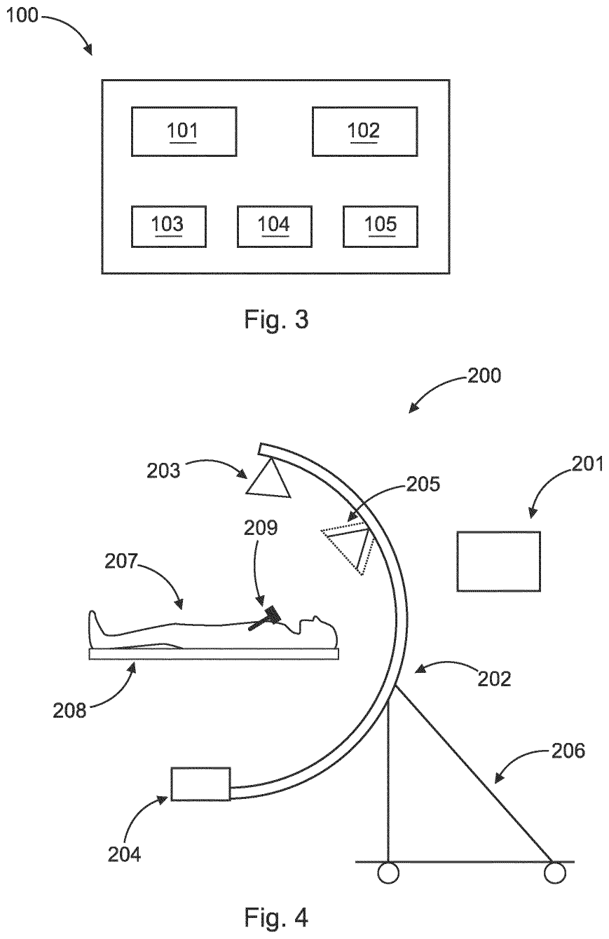

FIG. 3 shows a device 100 for assessing a quality measure of medical images, comprising: a receiving unit 101 configured to receive a first positioning data set configured to position an imaging source and an imaging detector of the medical imaging X-ray system in relation to an object to be imaged into a first imaging position; a first obtaining unit 102 configured to obtain a first medical image of the object from the first imaging position; a generating unit 103 configured to generate at least a second positioning data set configured to position the imaging source and the imaging detector of the medical imaging X-ray system in relation to the object to be imaged into a second imaging position, wherein the second positioning data set differs from the first positioning data set in at least one positioning parameter; a second obtaining unit 104 configured to obtain at least a second medical image of the object from the second imaging position; a determining unit 105 configured to determine at least one imaging quality measure in the first medical image and the at least second medical image and comparing the determined at least one imaging quality measure with a predefined threshold of the at least one imaging quality measure and deriving an assessment result, in case of a positive assessment result of the first medical image or the at least second medical image to select of the respective medical image with the positive assessment result and to provide the selected medical image and corresponding positioning data set for further processing, and in case of a negative assessment result of the first medical image or the at least second medical image to generate at least one further positioning data set and to obtain at least one further medical image, wherein the at least one further positioning data set differs from the first positioning data set and the second positioning data set in at least one positioning parameter, and to derive an assessment result of the at least one further medical image. The receiving unit 101, the first obtaining unit 102, the generating unit 103, the second obtaining unit 104 and the determining unit 105 are described as functional units. These functional units are in the present example implemented in a hardware, in particular a CPU with one or more interfaces for a communication with the medical imaging X-ray system.

FIG. 4 shows a system 200 for obtaining a medical image of an object. The system comprises a device 201 for assessing a quality measure of medical images as described above. The system 200 further comprises a medical imaging X-ray system 202 comprising an imaging source 203 and an imaging detector 204 arranged on a movable framework 206. The medical imaging X-ray system is in present example a C-arm X-ray system. The imaging source 203 and the imaging detector 204 may be positioned independently from each other. E.g., the imaging source 203 may positioned to the position 205 and the imaging detector 204 may remain at its position. A person 207 may be positioned on a support structure 208. The object 209 may be a screw arranged in a region of the person 207. The C-arm X-ray system may be arranged around the person 207 in order to obtain medical images of the object 209. The device 201 is in communication with the C-arm X-ray system by means of at least one interface.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the steps S10 to S50 can be performed in any order, i.e. the present invention is not limited to a specific order of these steps. Moreover, it is also not required that the different steps are performed at a certain place or at one place, i.e. each of the steps may be performed at a different place using different equipment/data processing units. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE SIGNS

10, 11, 12 alignment of an X-ray imaging system in relation to an object
13, 17, 21, 204 imaging detector
14, 18, 22, 203, 205 imaging source
15, 19, 23, 209 object
16, 20, 26 image
24, 25 direction
100, 201 device
101 receiving unit
102 first obtaining unit
103 generating unit
104 second obtaining unit
105 determining unit
200 system
202 X-ray system
206 X-ray system framework
207 human
208 support structure
S10 receiving first positioning data set
S20 obtaining first medical image
S30 generating second positioning data set
S40 obtaining second medical image
S50 determining imaging quality measure

1. A computer-implemented method of assessing an imaging quality measure of medical images, the method comprising:
receiving a first positioning data set configured to position an imaging source and an imaging detector of a medical imaging X-ray system in relation to an object to be imaged into a first imaging position;
obtaining a first medical image of the object from the first imaging position;
generating at least a second positioning data set configured to position the imaging source and the imaging detector of the medical imaging X-ray system in relation to the object to be imaged into a second imaging position, wherein the second positioning data set differs from the first positioning data set in at least one positioning parameter;
obtaining at least a second medical image of the object from the second imaging position;
determining at least one imaging quality measure in the first medical image and in the at least second medical image;
comparing the determined at least one imaging quality measure with an evaluation criterion of the at least one imaging quality measure; and
deriving an assessment result, wherein:
in case of a positive assessment result of the first medical image or the at least second medical image, the deriving comprises:
selecting the respective medical image with the positive assessment result; and
providing the selected medical image and the corresponding positioning data set for further processing; and
in case of a negative assessment result of the first medical image or the at least second medical image, the deriving comprises:
generating at least one further positioning data set configured to position the imaging source and the imaging detector of the medical imaging X-ray system in relation to the object to be imaged into a further imaging position;
obtaining at least one further medical image of the object from the further imaging position, wherein the at least one further positioning data set differs from the first positioning data set and the second positioning data set in at least one positioning parameter; and
deriving an assessment result of the at least one further medical image.

2. The method according to claim 1, wherein the at least one imaging quality measure comprises at least one of:
a maximum depicted length of the object;
a minimum area of the object;
an aspect ratio of the object;
a contour of the object;
a digital reconstructed radiograph of the object;
an inner contour of the object; and/or
a parameter of a directional change of an intensity or a color.

3-8. (canceled)

9. The method according to claim 1, wherein the first positioning data set, the second positioning data set, and the further positioning data set each comprise a first angle and/or a second angle of the imaging source and/or the imaging detector in relation to the object.

10. The method according to claim 9, comprising:
positioning the first angle of the imaging source and the first angle of the imaging detector are positioned independently from each other.

11. The method according to claim 1, wherein generating the at least second positioning data set comprises;
adding an incremental change to the at least one positioning parameter of the first positioning data set.

12. The method according to claim 11, wherein the added incremental change is either constant or variable depending on the assessment result, wherein the assessment result comprises a range with a plurality of entries.

13. The method according to claim 1, wherein the object is a medical element arranged in a human body.

14. The method according to claim 1, wherein the object is an area of an anatomy of a human body.

15. The method according to claim 1, wherein obtaining the at least second medical image comprises;
obtaining a plurality of medical images and corresponding positioning data.

16. The method according to claim 15, wherein the determining the at least one imaging quality measure in the at least second medical image comprises:
determining the at least one imaging quality measure in the at least second medical image directly after obtaining the at least second medical image and before obtaining a third medical image or the further medical image.

17. The method according to claim 1, wherein the determining the at least one imaging quality measure in the respective first medical image and the at least second medical image comprises:
determining, using an image processing algorithm, the at least one imaging quality measure in the respective first medical image and the at least second medical image.

18. The method according to claim 1, wherein the evaluation criterion is a predefined threshold.

19. The method according to claim 1, comprising:
deriving the evaluation criterion from the at least one imaging quality measure in the first medical image and in the at least second medical image.

20. A device for assessing a quality measure of medical images, comprising:
a receiving unit configured to receive a first positioning data set configured to position an imaging source and an imaging detector of a medical imaging X-ray system in relation to an object to be imaged into a first imaging position;
a first obtaining unit configured to obtain a first medical image of the object from the first imaging position;
a generating unit configured to generate at least a second positioning data set configured to position the imaging source and the imaging detector of the medical imaging X-ray system in relation to the object to be imaged into a second imaging position, wherein the second positioning data set differs from the first positioning data set in at least one positioning parameter;
a second obtaining unit configured to obtain at least a second medical image of the object from the second imaging position; and
a determining unit configured to:
determine at least one imaging quality measure in the first medical image and in the at least second medical image;
compare the determined at least one imaging quality measure with an evaluation criterion of the at least one imaging quality measure; and
derive an assessment result, wherein the determining unit is further configured to:
in case of a positive assessment result of the first medical image or the at least second medical image, select the respective medical image with the positive assessment result; and
provide the selected medical image and corresponding positioning data set for further processing; and
in case of a negative assessment result of the first medical image or the at least second medical image, generate at least one further positioning data set;
obtain at least one further medical image, wherein the at least one further positioning data set differs from the first positioning data set and the second positioning data set in at least one positioning parameter; and
derive an assessment result of the at least one further medical image.

21. A system for obtaining medical images of an object, comprising:
a medical imaging X-ray system comprising an imaging source and an imaging detector; and
a device for assessing a quality measure of medical images, comprising:
a receiving unit configured to receive a first positioning data set configured to position the imaging source and the imaging detector of the medical imaging X-ray system in relation to the object to be imaged into a first imaging position;
a first obtaining unit configured to obtain a first medical image of the object from the first imaging position;
a generating unit configured to generate at least a second positioning data set configured to position the imaging source and the imaging detector of the medical imaging X-ray system in relation to the object to be imaged into a second imaging position, wherein the second positioning data set differs from the first positioning data set in at least one positioning parameter;
a second obtaining unit configured to obtain at least a second medical image of the object from the second imaging position; and
a determining unit configured to:
determine at least one imaging quality measure in the first medical image and in the at least second medical image;
compare the determined at least one imaging quality measure with an evaluation criterion of the at least one imaging quality measure; and
derive an assessment result, wherein the determining unit is further configured to:
in case of a positive assessment result of the first medical image or the at least second medical image, select the respective medical image with the positive assessment result; and
provide the selected medical image and corresponding positioning data set for further processing; and
in case of a negative assessment result of the first medical image or the at least second medical image, generate at least one further positioning data set;
obtain at least one further medical image, wherein the at least one further positioning data set differs from the first positioning data set and the second positioning data set in at least one positioning parameter; and
derive an assessment result of the at least one further medical image.

22. The system according to claim 21, wherein the imaging source and imaging detector of the medical imaging X-ray system are configured to be positioned independently from each other.

23. (canceled)

24. The method according to claim 12, wherein the assessment result comprises more than 5 entries.

25. The device according to claim 20, wherein the at least one imaging quality measure comprises at least one of:
a maximum depicted length of the object;
a minimum area of the object;
an aspect ratio of the object;
a contour of the object;
a digital reconstructed radiograph of the object;
an inner contour of the object; and/or
a parameter of a directional change of an intensity or a color.

26. The device according to claim 20, wherein the first positioning data set, the second positioning data set, and the further positioning data set each comprise a first angle and/or a second angle of the imaging source and/or the imaging detector in relation to the object

27. The device according to claim 26, wherein the first angle of the imaging source and the first angle of the imaging detector are configured to be positioned independently from each other.
